(19) United States
(12) Patent Application Publication
(10) Pub. No.: US 2023/0325798 A1
(43) Pub. Date: Oct. 12, 2023

(54) SYSTEMS AND METHODS FOR REGULATING ACCESS AND TICKETING WITH NON-FUNGIBLE TOKENS

(71) Applicant: Afterparty, Inc., Los Angeles, CA (US)

(72) Inventors: David Richard FIELDS, Los Angeles, CA (US); Daniel John RAHMEL, Los Angeles, CA (US); Eytan Avinoam ELBAZ, Beverly Hills, CA (US); John Massey VAN LIERE, Los Angeles, CA (US)

(21) Appl. No.: 18/189,492

(22) Filed: Mar. 24, 2023

Related U.S. Application Data
(60) Provisional application No. 63/323,745, filed on Mar. 25, 2022.

(51) Int. Cl. G06Q 20/12; G06F 21/62

(52) U.S. Cl. CPC G06Q 20/1235; G06F 21/6209; G06Q 2220/10

(57) ABSTRACT

Described are systems and methods for providing and administering a NFT for Access.

### CROSS-REFERENCE TO RELATED APPLICATIONS

This application claims the priority and benefit of U.S. Provisional Application No. 63/323,745, filed Mar. 25, 2022, the content of which is incorporated herein by reference in its entirety.

### BACKGROUND

Non-fungible tokens (NFTs) are gaining in popularity and uses. There are many utilities, applications and use cases associated with NFTs. For example, NFTs are increasingly being used to represent digital art and collectibles, allowing creators to monetize their work and retain ownership and control over their digital assets. NFTs are being used in online gaming to represent in-game items, allowing players to buy, sell, and trade virtual assets with real-world value. NFTs are being used to represent sports collectibles such as trading cards, allowing fans to own a unique piece of sports history.

### SUMMARY

Musicians and artists are using NFTs to sell limited edition digital albums and concert tickets, providing fans with exclusive access and ownership of their work. NFTs can be used to verify and authenticate digital identities and assets, providing a secure and transparent system for record-keeping and verification.

Today, an NFT might come with certain utility, e.g. granting a person access to a certain event. Under current systems, a NFT Holder uses a crypto wallet, such as MetaMask Wallet or a Coinbase Wallet. The crypto wallet contains the holder’s NFTs.

In some cases, a creator of a NFT may want to treat the owner/holder of the NFT with something interesting, such as an event (e.g., a concert). The NFT creator may generate a Smart Contract that defines the utility and verifies ownership. For example, an event may be announced that allow any of the NFT’s holders to attend. For example, the Backstreet Boys might announce that any holders of a certain edition of a Backstreet Boys NFT, get to attend a concert. The Smart Contract should include the terms and conditions for the utility (i.e., grant of access to the concert) of the NFT, and it may verify ownership of the NFT before granting access to the utility.

After the announcement notice, the qualified NFT holders may choose to go to the event, and authenticate his/her ownership of the NFT. In some embodiments, the owner/holder of the NFT may sign a transaction on the blockchain to prove that they hold the NFT. This process can be done through a digital signature or other cryptographic means. In some cases, the holders may connect his/her crypto wallet to the event’s Smart Contract, which would determine that the NFT Holder in fact owns the specific NFT necessary to attend the event. Upon authentication, the event allows the NFT Holder into the event.

Using NFTs for event access presents several challenges that need to be addressed to ensure the security and utility of the NFTs. The first problem is that NFTs can hold significant value, and this poses a security risk when the owner needs to prove they are still holding the NFT directly. The requirement to have the private keys on the device at the event could expose the holder to the risk of theft or loss of their private keys, which could result in the loss of their NFTs. This concern highlights the need for a secure and trustworthy mechanism for authenticating NFT ownership that does not require the holder to expose their private keys.

The second issue is that once an NFT holder has gained access to an event using their NFT, there is no mechanism for transferring that access to another person. This limitation makes it difficult for holders to grant access to their NFTs to a second party without transferring ownership of the NFT, which could create problems with maintaining the NFT’s utility level. For example, once an NFT has been used to grant access to an event, it would be challenging to ensure that the first or third party has not already used that access, making it difficult to maintain the NFT’s utility level.

Given these issues, NFTs with utility often have a process for signing a transaction on the blockchain proving you hold the NFT beforehand and giving a user a unique QR code. Once the transaction is verified on the blockchain, the system may generate a unique QR code that can be used to authenticate the owner’s access to the utility. The QR code can be displayed on the owner’s device or printed out for use at the event.

This solution poses several additional challenges. One such issue is that once a unique identifier, such as a QR code, is generated for the NFT, it can be sold to a new buyer without any assurance that the NFT’s utility has not already been used or accessed. This lack of transparency and accountability raises questions about the integrity of the NFT and its value. Additionally, the current technologies available fail to ensure that the NFT’s utility is always maintained at the NFT level, creating doubts about the authenticity of the NFT even after it has been transferred to a new owner.

Furthermore, there is currently no reliable way for NFT holders to grant access to a second party without compromising the NFT’s utility. For instance, if an NFT grants access to an event or service, how can the holder of the event access ensure that the first party or a third party has not already used that access before transferring it to a new party? This lack of accountability and transparency can lead to disputes and a loss of trust in the NFT ecosystem.

To address these challenges, the methods, processes and systems described herein may generate unique identifying access codes (UIACs) for NFTs that correspond to the access granted by the NFT. These UIACs are automatically checked for transfers on the blockchain, and any previously associated UIACs are rendered unusable once the NFT is transferred to a new owner. This ensures that the new owner has complete confidence that the NFT still retains its utility, and any access granted through the UIAC has not been used or accessed previously. Additionally, the NFT owner can still maintain ownership and control of their NFT while sending the UIAC to a trusted party.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 shows a non-limiting example of a computing device; in this case, a device with one or more processors, memory, storage, and a network interface;

FIG. 2 shows a non-limiting example of a web/mobile application provision system; in this case, a system providing browser-based and/or native mobile user interfaces;

FIG. 3 shows a non-limiting example of a cloud-based web/mobile application provision system; in this case, a system comprising an elastically load balanced, auto-scaling web server and application server resources as well synchronously replicated databases;

FIGS. 4-6 shows a non-limiting example of a crypto wallet including features of the systems and methods described herein; in this case, a crypto wallet allowing a user to view owned NFTs for Access, view a selected NFT for Access, and view a unique identifying access code (UIAC) associated with a selected NFT for Access;

FIG. 7 shows a non-limiting example of a graphic user interface (GUI); in this case, a GUI for claiming UIACs associated with a currently owned NFT for Access;

FIG. 8 shows a non-limiting example of a GUI; in this case, a GUI for claiming UIACs associated with a NFT for Access, wherein the NFT was previously owned subsequently sold such that the UIACs are invalidated;

FIG. 9 shows a non-limiting example of a process flow diagram; in this case, a process flow diagram illustrating a process wherein a user purchases a NFT for Access, claims tickets associated with the NFT, and uses the tickets to access an event; and

FIG. 10 shows a non-limiting example of a process flow diagram; in this case, a process flow diagram illustrating a process wherein a user purchases a NFT for Access, claims tickets associated with the NFT, but subsequently sells or transfers the NFT, however, the new owner can claim the tickets and the previously claimed tickets are invalidated.

### DETAILED DESCRIPTION

### Certain Definitions

Unless otherwise defined, all technical terms used herein have the same meaning as commonly understood by one of ordinary skill in the art to which the present subject matter belongs.

As used in this specification and the appended claims, the singular forms “a,” “an,” and “the” include plural references unless the context clearly dictates otherwise. Any reference to “or” herein is intended to encompass “and/or” unless otherwise stated.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

Described herein are computer-implemented systems comprising at least one computing device comprising at least one processor and instructions executable by the at least one processor to perform operations comprising: providing a non-fungible token (NFT) for access, wherein the NFT for access is associated with one or more unique identifier access codes (UIACs); presenting an interface allowing a user to prove ownership of the NFT for access and view the status of the UIACs; monitoring for transfers or sales of the NFT for access on the blockchain; if a transfer or sale of the NFT for access is detected: de-authenticating all UIACs previously associated with the NFT for access; and creating one or more new UIACs associated with the NFT for access. In some embodiments, the one or more UIACs comprises: a ticket, a QR code, an alphanumeric code, a bar code, another NFT, or a combination thereof. In some embodiments, the one or more UIACs provides access to a physical event, a digital event, or a combination thereof. In some embodiments, the one or more UIACs is associated with the NFT for access at the time of NFT minting. In other embodiments, the one or more UIACs is associated with the NFT for access after the minting of the NFT. In yet other embodiments, the one or more UIACs is associated with the NFT for access when a user requests the one or more UIACs. In some embodiments, the operations further comprise providing the one or more new UIACs to the transferee or buyer.

Also described herein are computer-implemented methods of operating a NFT for Access comprising: providing a non-fungible token (NFT) for access, wherein the NFT for access is associated with one or more unique identifier access codes (UIACs); presenting an interface allowing a user to prove ownership of the NFT for access and view the status of the UIACs; monitoring for transfers or sales of the NFT for access on the blockchain; if a transfer or sale of the NFT for access is detected: de-authenticating all UIACs previously associated with the NFT for access; and creating one or more new UIACs associated with the NFT for access. In some embodiments, the one or more UIACs comprises: a ticket, a QR code, an alphanumeric code, a bar code, another NFT, or a combination thereof. In some embodiments, the one or more UIACs provides access to a physical event, a digital event, or a combination thereof. In some embodiments, the one or more UIACs is associated with the NFT for access at the time of NFT minting. In other embodiments, the one or more UIACs is associated with the NFT for access after the minting of the NFT. In yet other embodiments, the one or more UIACs is associated with the NFT for access when a user requests the one or more UIACs. In some embodiments, the method further comprises providing the one or more new UIACs to the transferee or buyer.

### Computing System

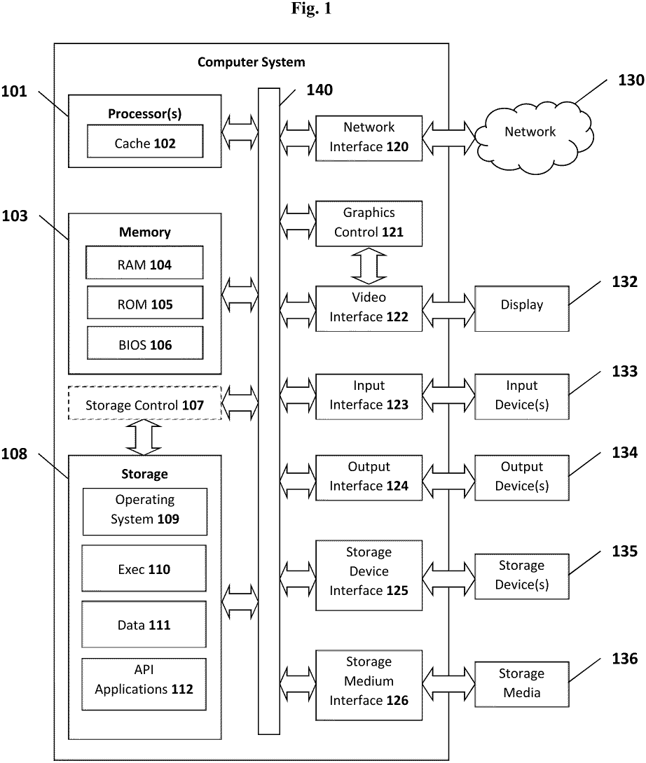

Referring to FIG. 1, a block diagram is shown depicting an exemplary machine that includes a computer system 100 (e.g., a processing or computing system) within which a set of instructions can execute for causing a device to perform or execute any one or more of the aspects and/or methodologies for static code scheduling of the present disclosure. The components in FIG. 1 are examples only and do not limit the scope of use or functionality of any hardware, software, embedded logic component, or a combination of two or more such components implementing particular embodiments.

Computer system 100 may include one or more processors 101, a memory 103, and a storage 108 that communicate with each other, and with other components, via a bus 140. The bus 140 may also link a display 132, one or more input devices 133 (which may, for example, include a keypad, a keyboard, a mouse, a stylus, etc.), one or more output devices 134, one or more storage devices 135, and various tangible storage media 136. All of these elements may interface directly or via one or more interfaces or adaptors to the bus 140. For instance, the various tangible storage media 136 can interface with the bus 140 via storage medium interface 126. Computer system 100 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 100 includes one or more processor(s) 101 (e.g., central processing units (CPUs), general purpose graphics processing units (GPGPUs), or quantum processing units (QPUs)) that carry out functions. Processor(s) 101 optionally contains a cache memory unit 102 for temporary local storage of instructions, data, or computer addresses. Processor(s) 101 are configured to assist in execution of computer readable instructions. Computer system 100 may provide functionality for the components depicted in FIG. 1 as a result of the processor(s) 101 executing non-transitory, processor-executable instructions embodied in one or more tangible computer-readable storage media, such as memory 103, storage 108, storage devices 135, and/or storage medium 136. The computer-readable media may store software that implements particular embodiments, and processor(s) 101 may execute the software. Memory 103 may read the software from one or more other computer-readable media (such as mass storage device(s) 135, 136) or from one or more other sources through a suitable interface, such as network interface 120. The software may cause processor(s) 101 to carry out one or more processes or one or more steps of one or more processes described or illustrated herein. Carrying out such processes or steps may include defining data structures stored in memory 103 and modifying the data structures as directed by the software.

The memory 103 may include various components (e.g., machine readable media) including, but not limited to, a random access memory component (e.g., RAM 104) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 105 may act to communicate data and instructions unidirectionally to processor(s) 101, and RAM 104 may act to communicate data and instructions bidirectionally with processor(s) 101. ROM 105 and RAM 104 may include any suitable tangible computer-readable media described below. In one example, a basic input/output system 106 (BIOS), including basic routines that help to transfer information between elements within computer system 100, such as during start-up, may be stored in the memory 103.

Fixed storage 108 is connected bidirectionally to processor(s) 101, optionally through storage control unit 107. Fixed storage 108 provides additional data storage capacity and may also include any suitable tangible computer-readable media described herein. Storage 108 may be used to store operating system 109, executable(s) 110, data 111, applications 112 (application programs), and the like. Storage 108 can also include an optical disk drive, a solid-state memory device (e.g., flash-based systems), or a combination of any of the above. Information in storage 108 may, in appropriate cases, be incorporated as virtual memory in memory 103.

In one example, storage device(s) 135 may be removably interfaced with computer system 100 (e.g., via an external port connector (not shown)) via a storage device interface 125. Particularly, storage device(s) 135 and an associated machine-readable medium may provide non-volatile and/or volatile storage of machine-readable instructions, data structures, program modules, and/or other data for the computer system 100. In one example, software may reside, completely or partially, within a machine-readable medium on storage device(s) 135. In another example, software may reside, completely or partially, within processor(s) 101.

Bus 140 connects a wide variety of subsystems. Herein, reference to a bus may encompass one or more digital signal lines serving a common function, where appropriate. Bus 140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 100 may also include an input device 133. In one example, a user of computer system 100 may enter commands and/or other information into computer system 100 via input device(s) 133. Examples of an input device(s) 133 include, but are not limited to, an alphanumeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 133 may be interfaced to bus 140 via any of a variety of input interfaces 123 (e.g., input interface 123) including, but not limited to, serial, parallel, game port, USB, FIREWIRE, THUNDERBOLT, or any combination of the above.

In particular embodiments, when computer system 100 is connected to network 130, computer system 100 may communicate with other devices, specifically mobile devices and enterprise systems, distributed computing systems, cloud storage systems, cloud computing systems, and the like, connected to network 130. Communications to and from computer system 100 may be sent through network interface 120. For example, network interface 120 may receive incoming communications (such as requests or responses from other devices) in the form of one or more packets (such as Internet Protocol (IP) packets) from network 130, and computer system 100 may store the incoming communications in memory 103 for processing. Computer system 100 may similarly store outgoing communications (such as requests or responses to other devices) in the form of one or more packets in memory 103 and communicated to network 130 from network interface 120. Processor(s) 101 may access these communication packets stored in memory 103 for processing.

Examples of the network interface 120 include, but are not limited to, a network interface card, a modem, and any combination thereof. Examples of a network 130 or network segment 130 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 130, may employ a wired and/or a wireless mode of communication. In general, any network topology may be used.

Information and data can be displayed through a display 132. Examples of a display 132 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 132 can interface to the processor(s) 101, memory 103, and fixed storage 108, as well as other devices, such as input device(s) 133, via the bus 140. The display 132 is linked to the bus 140 via a video interface 122, and transport of data between the display 132 and the bus 140 can be controlled via the graphics control 121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 132, computer system 100 may include one or more other peripheral output devices 134 including, but not limited to, an audio speaker, a printer, a storage device, and any combinations thereof. Such peripheral output devices may be connected to the bus 140 via an output interface 124. Examples of an output interface 124 include, but are not limited to, a serial port, a parallel connection, a USB port, a FIREWIRE port, a THUNDERBOLT port, and any combinations thereof.

In addition or as an alternative, computer system 100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device’s hardware and provides services for execution of applications. Those of skill in the art will recognize that suitable server operating systems include, by way of non-limiting examples, FreeBSD, OpenBSD, NetBSD^{®}, Linux, Apple^{®} Mac OS X Server^{®}, Oracle^{®} Solaris^{®}, Windows Server^{®}, and Novell^{®} NetWare^{®}. Those of skill in the art will recognize that suitable personal computer operating systems include, by way of non-limiting examples, Microsoft^{®} Windows^{®}, Apple^{®} Mac OS X^{®}, UNIX^{®}, and UNIX-like operating systems such as GNU/Linux^{®}. In some embodiments, the operating system is provided by cloud computing. Those of skill in the art will also recognize that suitable mobile smartphone operating systems include, by way of non-limiting examples, Nokia^{®} Symbian^{®} OS, Apple^{®} iOS^{®}, Research In Motion^{®} BlackBerry OS^{®}, Google^{®} Android^{®}, Microsoft^{®} Windows Phone^{®} OS, Microsoft^{®} Windows Mobile^{®} OS, Linux^{®}, and Palm^{®} WebOS^{®}. Those of skill in the art will also recognize that suitable media streaming device operating systems include, by way of non-limiting examples, Apple TV^{®}, Roku^{®}, Boxee^{®}, Google TV^{®}, Google Chromecast^{®}, Amazon Fire^{®}, and Samsung^{®} HomeSync^{®}. Those of skill in the art will also recognize that suitable video game console operating systems include, by way of non-limiting examples, Sony^{®} PS3^{®}, Sony^{®} PS4^{®}, Microsoft^{®}Xbox 360^{®}, Microsoft Xbox One, Nintendo^{®} Wii^{®}, Nintendo^{®} Wii U^{®}, and Ouya^{®}.

### Non-transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device’s CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft^{®} .NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft^{®} SQL Server, mySQL™, and Oracle^{®}. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash^{®} ActionScript, JavaScript, or Silverlight^{®}. In some embodiments, a web application is written to some extent in a server-side coding language such as Active Server Pages (ASP), ColdFusion^{®}, Perl, Java™, JavaServer Pages (JSP), Hypertext Preprocessor (PHP), Python™, Ruby, Tcl, Smalltalk, WebDNA^{®}, or Groovy. In some embodiments, a web application is written to some extent in a database query language such as Structured Query Language (SQL). In some embodiments, a web application integrates enterprise server products such as IBM^{®} Lotus Domino^{®}. In some embodiments, a web application includes a media player element. In various further embodiments, a media player element utilizes one or more of many suitable multimedia technologies including, by way of non-limiting examples, Adobe^{®} Flash^{®}, HTML 5, Apple^{®} QuickTime^{®}, Microsoft^{®}Silverlight^{®}, Java™, and Unity^{®}.

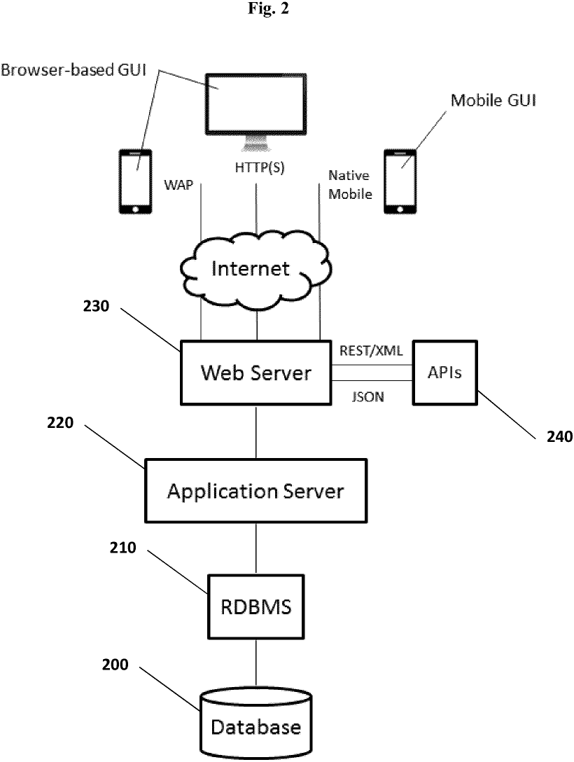

Referring to FIG. 2, in a particular embodiment, an application provision system comprises one or more databases 200 accessed by a relational database management system (RDBMS) 210. Suitable RDBMSs include Firebird, MySQL, PostgreSQL, SQLite, Oracle Database, Microsoft SQL Server, IBM DB2, IBM Informix, SAP Sybase, Teradata, and the like. In this embodiment, the application provision system further comprises one or more application severs 220 (such as Java servers, .NET servers, PHP servers, and the like) and one or more web servers 230 (such as Apache, IIS, GWS and the like). The web server(s) optionally expose one or more web services via app application programming interfaces (APIs) 240. Via a network, such as the Internet, the system provides browser-based and/or mobile native user interfaces.

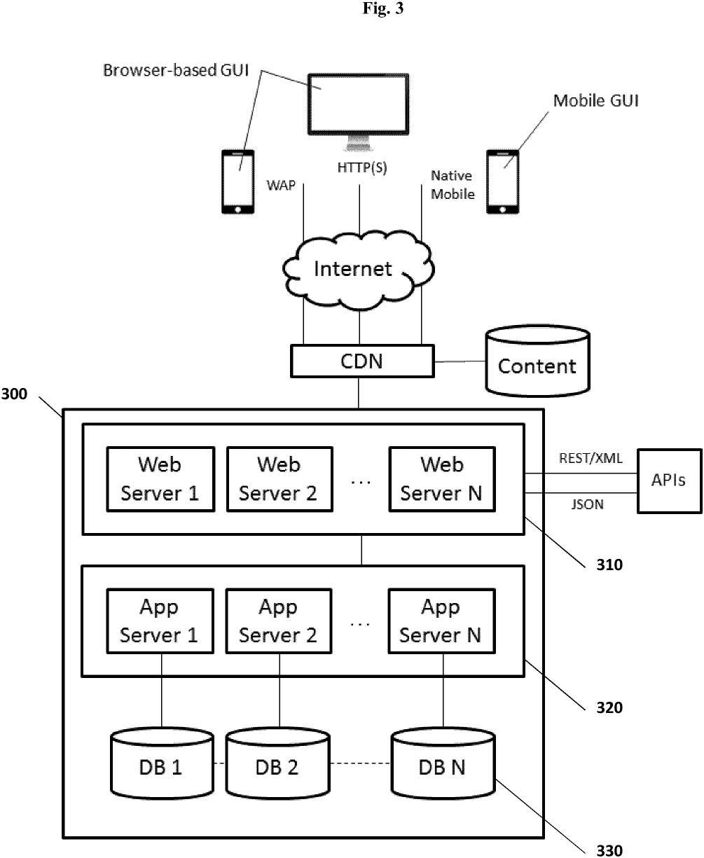

Referring to FIG. 3, in a particular embodiment, an application provision system alternatively has a distributed, cloud-based architecture 300 and comprises elastically load balanced, auto-scaling web server resources 310 and application server resources 320 as well synchronously replicated databases 330.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator^{®}, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry^{®} SDK, BREW SDK, Palm^{®} OS SDK, Symbian SDK, webOS SDK, and Windows^{®} Mobile SDK.

Those of skill in the art will recognize that several commercial forums are available for distribution of mobile applications including, by way of non-limiting examples, Apple^{®} App Store, Google^{®} Play, Chrome WebStore, BlackBerry^{®} App World, App Store for Palm devices, App Catalog for webOS, Windows^{®} Marketplace for Mobile, Ovi Store for Nokia^{®} devices, Samsung^{®} Apps, and Nintendo^{®} DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe^{®} Flash^{®} Player, Microsoft^{®}Silverlight^{®}, and Apple^{®} QuickTime^{®}. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft^{®}Internet Explorer^{®}, Mozilla^{®} Firefox^{®}, Google^{®} Chrome, Apple^{®} Safari^{®}, Opera Software^{®} Opera^{®}, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google^{®} Android^{®} browser, RIM BlackBerry^{®} Browser, Apple^{®} Safari^{®}, Palm^{®} Blazer, Palm^{®} WebOS^{®} Browser, Mozilla^{®} Firefox^{®} for mobile, Microsoft^{®}Internet Explorer^{®} Mobile, Amazon^{®} Kindle^{®} Basic Web, Nokia^{®} Browser, Opera Software^{®} Opera^{®} Mobile, and Sony^{®} PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user, minter, NFT, event, access, ticketing, sale, and purchase information. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

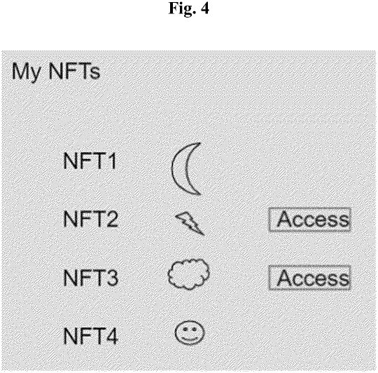

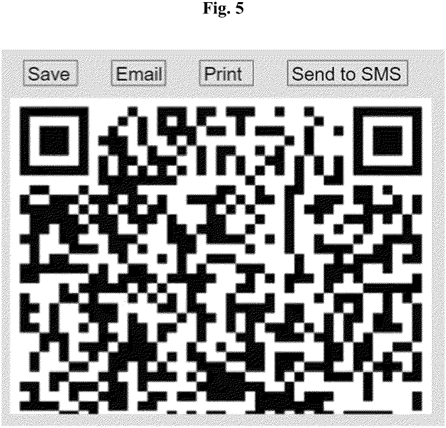

FIGS. 4-6 shows a non-limiting example of a crypto wallet including features of the systems and methods described herein; in this case, a crypto wallet allowing a user to view owned NFTs for Access, view a selected NFT for Access, and view a unique identifying access code (UIAC) associated with a selected NFT for Access. As shown in FIG. 4, a digital wallet user interface is presented to a user, wherein the user interface shows the NFTs the user holds, and/or which ones out of all NFT holdings have an event access. This digital wallet allows users to easily view their owned NFTs for access, select a specific NFT for access, and view the corresponding unique identifying access code (UIAC). In FIG. 4, the user is presented with a clear and user-friendly interface that displays their NFT holdings, along with any NFTs that provide access to events or experiences. This allows the user to quickly identify which NFTs they can use to gain access to exclusive events or experiences. As shown in FIG. 5, a user interface is presented to a user, wherein the UIAC (e.g., in a form of bar code) is presented. The user may choose a number of actions with regard to the UIAC, for example, to save it locally or on cloud, email it, print it, or send via SMS. This feature is particularly useful as it enables users to transfer the UIAC without having to transfer the underlying NFT. This way, users can enjoy the benefits of an NFT for access while still retaining ownership of the underlying asset. In addition, the crypto wallet may have other functionalities that are not explicitly shown in the figures. For instance, it may allow users to search for specific NFTs or filter their holdings by various criteria. It may also provide information on upcoming events that are available to NFT holders, and allow users to purchase new NFTs directly within the wallet.

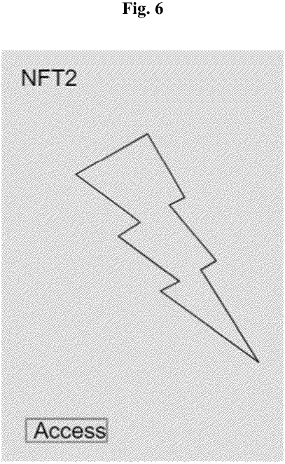

In this non-limiting example, FIG. 6 depicts a user interface that allows a user to view one of their owned NFTs and access more information about the grant of access associated with it. If the user clicks the “access” button, it may trigger a link to the user interface shown in FIG. 5, where they can view and manage the unique identifying access code (UIAC) associated with the NFT. The user can take various actions with the UIAC, such as saving it locally or on the cloud, emailing it, printing it, or sending it via SMS.

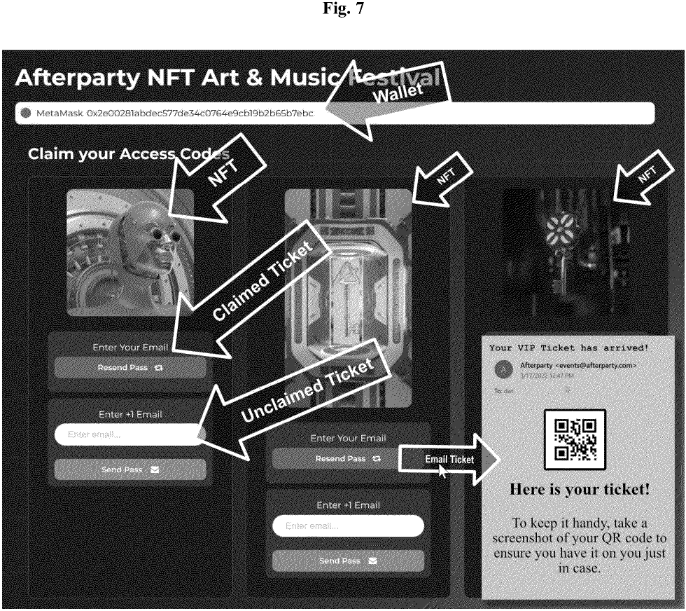

In some embodiments, by clicking the “access” button, the user interface in FIG. 6 may link and present the user with the interface in FIG. 7. FIG. 7 shows a non-limiting example of a graphic user interface (GUI); in this case, a GUI for claiming UIACs associated with a currently owned NFT for Access. In some embodiments, the user may be presented with the information of the events associated with one or more NFTs. For example, as shown in FIG. 7, the GUI may present the user with a number of events and/or the claim/redemption status of the access to the event (i.e., a pass). As shown in FIG. 7, the claimed tickets may be shown in a different color and/or shade of color than the unclaimed tickets. In some embodiments, the passes/tickets/accesses to events are currently-owned by a user. In some embodiments, the GUI may allow users to resend passes if the pass has already been claimed. Additionally, the GUI may allow users to claim an unclaimed pass by entering an email address. In some embodiments, the claimed pass/ticket may be in the form of a combination of a UIAC and related information.

In some embodiments, the crypto wallet and accompanying interfaces described herein may provide a streamlined way for users to manage their NFTs and access to events. The GUIs in FIGS. 5, 6, and 7 allow users to view their NFTs, view a selected NFT for access, and claim passes to events associated with the NFTs. By allowing users to easily transfer UIACs without transferring the underlying NFTs, the crypto wallet provides an added layer of security and flexibility.

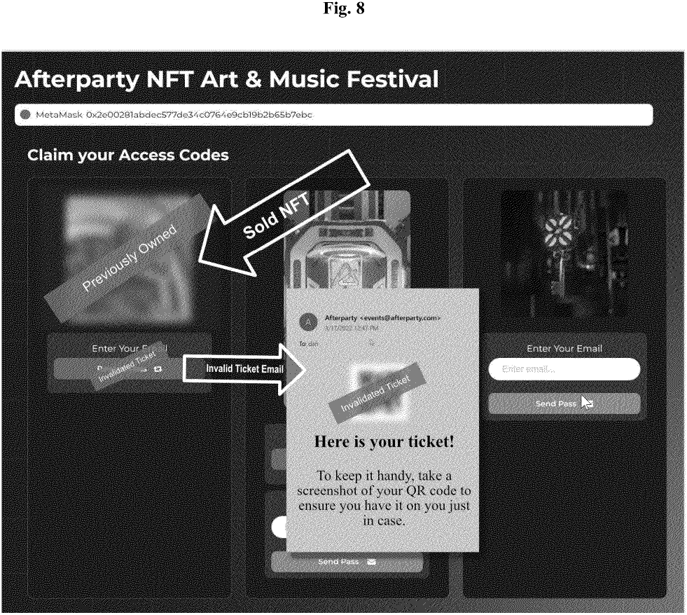

FIG. 8 illustrates an example of a graphical user interface (GUI) for claiming UIACs associated with a previously-owned NFT for Access, wherein the UIACs have become invalidated due to the sale of the NFT. In some embodiments, when an NFT is sold, the associated UIACs may become invalid or void. The GUI shown in FIG. 8 may present the user with the previously-owned passes or tickets, and indicates that they are no longer valid. In some embodiments, the GUI may also indicate that the tickets are “sold” or “transferred” to another party.

As shown in FIG. 8, the GUI may also indicate that the underlying NFT has been sold by marking it as “sold.” In some embodiments, this may help the user keep track of their NFTs and associated passes/tickets, and avoid confusion or errors when attempting to claim an invalid pass/ticket. In some embodiments, the GUI may present to a user with the previously-owned passes/tickets, and mark them as the invalidated. In some embodiments, the GUI may mark those tickets as “sold.” As shown in FIG. 8, the GUI may mark an underlying NFT as “sold” if it was the case, and the associated passes/tickets are also marked as invalid by extension. It should be noted that while the example shown in FIG. 8 pertains to a NFT that has been sold, the GUI may also be used in other scenarios where UIACs associated with an NFT become invalidated, such as expiration of the access period or revocation of the access grant. The GUI may help the user manage their NFTs and associated access rights more efficiently and effectively.

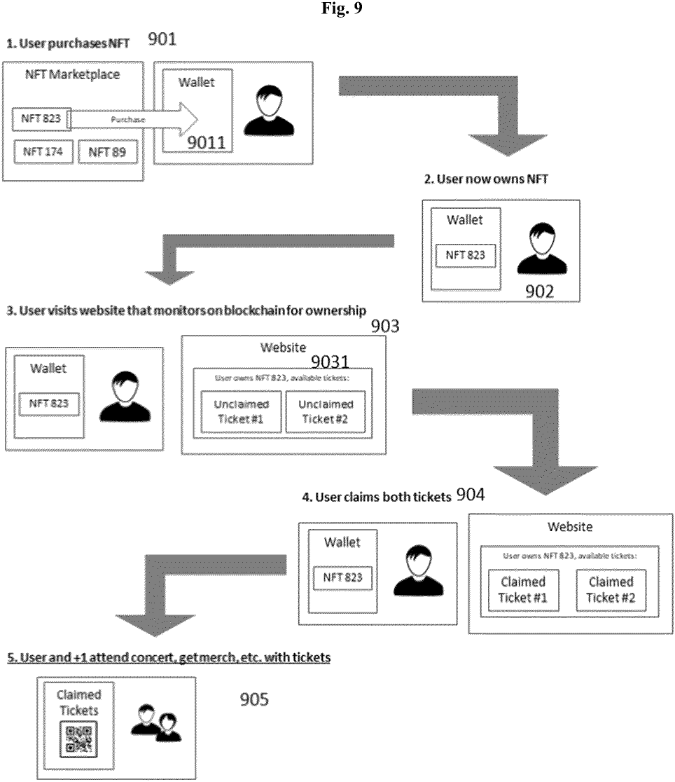

FIG. 9 shows a non-limiting example of a process flow diagram; in this case, a process flow diagram illustrating a process wherein a user purchases a NFT for Access, claims tickets associated with the NFT, and uses the tickets to access an event. As shown in FIG. 9, a user may purchase 901 NFT on a NFT marketplace, for example, a user may purchase NFT 823, NFT 174, and NFT 89, and those NFTs are added to the user’s digital wallet 9011. By this time, the user may be the holder/owner of the purchase NFTs, and it may show in the user digital wallet, for example, as the example shown in element 902 of FIG. 9. In some embodiments, this element 902 may be in a form that is shown in FIG. 4. In some embodiments, the user may receive an announcement that one or more NFTs may be associated with one or more utilities, such as events. In some embodiments, the user may visit 903 a website that monitors on blockchain for ownership, for example, to view whether one or more events/tickets may be issued to one or more NFTs that this user owns. As shown in FIG. 9, the website may identify that an NFT (e.g., NFT 823) may have two unclaimed tickets associated with the NFT, as shown by element 9031 of FIG. 9. In some embodiments, the owner of this NFT 823 may claim these tickets (i.e., utility, access to an event in this case), as shown by element 904 of FIG. 9. In some embodiments, the claimed tickets may be in a form of barcode, a QR code, an alphanumeric code, and/or another NFT. The user may use the claimed ticket to access an event (e.g., attend a concert, get merch, etc.), as shown by element 905 of FIG. 9.

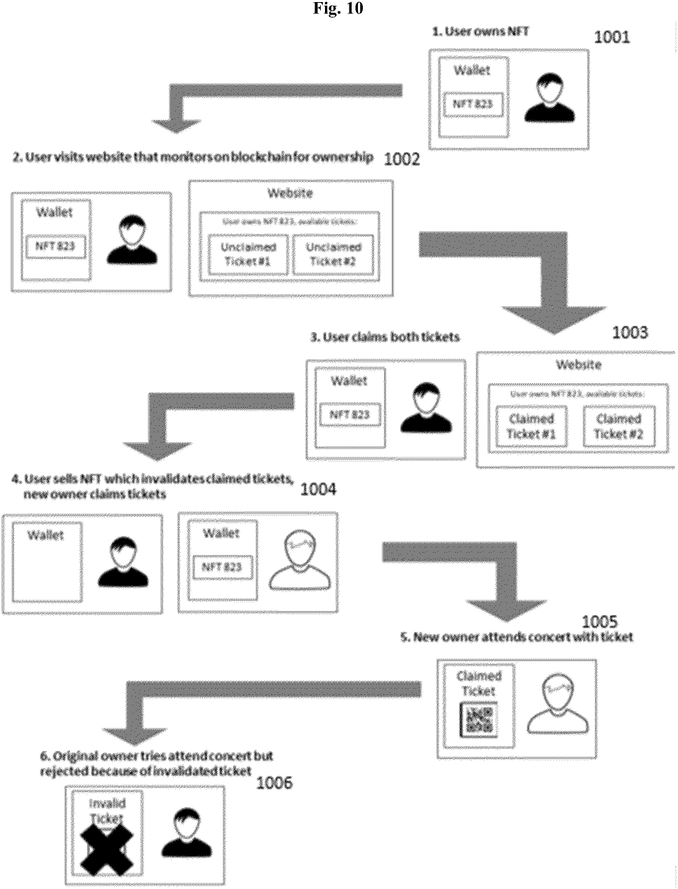

FIG. 10 shows a non-limiting example of a process flow diagram; in this case, a process flow diagram illustrating a process wherein a user purchases a NFT for Access, claims tickets associated with the NFT, but subsequently sells or transfers the NFT, however, the new owner can claim the tickets and the previously claimed tickets are invalidated. As shown in FIG. 10, a user may own a set of NFTs, which may show in the user’s digital wallet, as shown by element 1001 of FIG. 10. In some embodiments, the user may receive an announcement that one or more NFTs may be associated with one or more utilities, such as events. In some embodiments, the user may visit a website that monitors on blockchain for ownership, for example, to view whether one or more events/tickets may be issued to one or more NFTs that this user owns, as shown by element 1002 of FIG. 10. As shown in FIG. 10, the website may identify that an NFT (e.g., NFT 823) may have two unclaimed tickets associated with the NFT. In some embodiments, the owner of this NFT 823 may claim 1003 these tickets (i.e., utility, access to an event in this case). In some embodiments, the claimed tickets may be in a form of barcode, a QR code, an alphanumeric code, and/or another NFT. In some embodiments, the user may choose to transfer the NFT, for example, sell, donate, gift, or otherwise devise the ownership of the NFT, as shown by element 1004 of FIG. 10. In this case, the system provided herein may: (a) check for NFT transfers on the blockchain and (b) de-authenticate/disallow all previously associated unique identifiers. All previously associated UIDs/UIACs, whether they had been known to the buyer, or unknown to the buyer, will be rendered unusable. In some embodiments, the system may create a brand new set of UIDs/UIACs for the new buyer. As shown in FIG. 10, the new owner may attend 1005 the concert with the ticket, and the old owner (in some cases, the original owner) may be denied access 1006 to the concert because the claimed ticket has been invalidated by the system.

### Various Embodiments

Described herein, in some embodiments, are processes and various methods for guaranteeing ticketing and access using NFTs. Also described herein, in various embodiments are an NFT, which is a one-of-a-kind, digital object on a blockchain that serves as an “NFT for Access.” This NFT has various function, which includes, but is not limited to, utility that enables access to events in both the physical and digital realms, as well as in metaverses. Examples of such events may include concerts, festivals, meetups, conferences, parties, dinners, meet and greets, and more. In some embodiments, the process for using NFTs to guarantee ticketing and access involves creating a unique NFT for each event. This NFT is then sold to interested parties, who can use it to gain entry to the corresponding event. The NFT may be linked to a smart contract that specifies the terms and conditions of entry, such as the date, time, and location of the event, as well as any applicable fees or restrictions. In some embodiments, the NFT for Access may be used as a form of digital authentication for events in both physical and virtual spaces. This can be particularly useful for events authentication, as the NFT can serve as proof of purchase and grant access to the event. Additionally, the NFT can be used to track attendance, prevent fraud, and facilitate the transfer of ownership.

A purchaser of an NFT for Access would want to guarantee that the utility associated with the NFT has not been previously used, and is still available to them, once they have purchased the NFT. When purchasing an NFT for Access, the buyer wants to ensure that the associated utility has not been used previously and remains available to them.

The NFT for Access is associated with a set of unique identifiers, which will be signified in the form of, by way of non-limiting examples, a ticket, QR Code, Promo Code, bar code, or any other unique alphanumeric code.

The NFT for Access can either be associated with these unique identifier originally at the time of NFT creation, sometime after the creation of the NFT, or when an end user requests the set of unique identifiers. In some embodiments, the process of associating the NFT for Access with unique identifiers may occur at different stages. It may happen during the initial creation of the NFT, at a later point after the NFT is created, or when an end user requests the set of unique identifiers. This allows for flexibility and customization in terms of how the NFT for Access is linked to its associated utility. For instance, the unique identifiers may be assigned during the NFT creation process, or they may be added later when the NFT holder requests them. This can also help to ensure that the NFT’s utility remains secure and is only accessible to the appropriate parties.

The NFT for Access provides its holder with various options for selling or transferring ownership of the NFT. There are different reasons why a holder might choose to do so, such as a) seeking financial gain by selling the NFT, b) being unable to utilize the utility associated with the NFT anymore, c) gifting or donating the NFT to someone else, or d) simply wanting to transfer ownership for any other reason. The ability to sell or transfer an NFT for Access also may provide the benefits of blockchain technology, as it allows for secure and transparent transactions between parties without the need for intermediaries. This opens up new possibilities for exchanging ownership of unique and valuable digital assets in a decentralized manner.

After the NFT for Access is sold or transferred, the new owner will want to ensure that they can utilize the utility associated with the NFT. However, if the previous owner already accessed the unique identifiers such as QR Code, Promo Code, Bar Code, etc., the new owner may have concerns that the previous owner will continue to use the utility associated with the NFT, such as the tickets to a concert. These unique identifiers, also known as Unique Identifying Access Codes (UIACs), may have been previously shared or distributed by the original owner, making it difficult for the new owner to guarantee exclusive access to the utility.

To prevent any potential misuse of the UIACs, the system provided herein may automatically: (a) check for NFT transfers on the blockchain and (b) de-authenticate/disallow all previously associated unique identifiers. All previously associated UIDs/UIACs, whether they had been known to the buyer, or unknown to the buyer, will be rendered unusable. This means that even if the previous owner had access to the UIACs, they will no longer be able to utilize them once the NFT is transferred to the new owner. The system will then generate a new set of UIACs exclusively for the new owner. The new UIACs can either be automatically provided to the new owner, or they can request to view the codes through the system. This way, the new owner can be certain that they have exclusive access to the utility associated with the NFT for Access.

### Exemplary Use Case

An NFT Holder uses a crypto wallet, such as MetaMask Wallet or a Coinbase Wallet. The crypto wallet contains the holder’s NFTs. When an event is announced, any holders of a specific NFT may be granted access to the event. For example, the Backstreet Boys might announce that anyone who holds a certain edition of their NFT (NFT for Access #1) may attend their concert. The verification process for NFT for Access #1 may be completed through a Smart Contract that may sign on the website, spawning a new UIAC, or other unique identifying access codes. The UIAC could take many forms, such as a QR code, an Access Code, a Promo Code, a Bar Code, or even another NFT.

The systems and methods described herein could offer a seamless way for NFT holders to gain access to this UIAC through a “1 Click to Access” or “1 Click to QR Code” option. Clicking on “1 Click to QR Code” would bring up the QR code on the screen. This UIAC could be printable onto a phone screen, available in an application, or on a printed sheet of paper.

The NFT Holder can use the UIAC to gain entry to the event or transmit it to someone else, such as a friend, family member, or buyer of access to the event. At the event, the NFT Holder would authenticate their ownership of the NFT by presenting the UIAC to the event coordinator. The UIAC would be scanned, just like a typical QR code, to verify its authenticity. If the NFT has not been transferred since the creation of the UIAC, the QR code will be authenticated, and the NFT Holder will be granted entry to the event. However, if the NFT has been transferred, the QR code will not be authenticated, and the NFT Holder will be denied entry.

### Solutions to New Issues Arising From the Application of Technology

The systems and methods described herein enable a behavior that was not previous possible until we invented it. At the same time, it offers a new complication, and that is: If an NFT Holder granted his access to a second person, but then sold his NFT to a third person under the guise that the access had not been granted elsewhere, it could cause two different people to believe they both had access to the event. The systems and methods described herein, address this new issue via the Smart Contract, which is coded such that any time the original NFT for Access is transferred, sold, or otherwise granted to a second party, the original UIAC is invalidated, and the Smart Contract created a brand new UIAC.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

What is claimed is:

1. A computer-implemented system comprising at least one computing device comprising at least one processor and instructions executable by the at least one processor to perform operations comprising:
a) providing a non-fungible token (NFT) for access, wherein the NFT for access is associated with one or more unique identifier access codes (UIACs);
b) presenting an interface allowing a user to prove ownership of the NFT for access and view the status of the UIACs;
c) monitoring for transfers or sales of the NFT for access on the blockchain;
d) if a transfer or sale of the NFT for access is detected:
i) de-authenticating all UIACs previously associated with the NFT for access; and
ii) creating one or more new UIACs associated with the NFT for access.

2. The system of claim 1, wherein the one or more UIACs comprises: a ticket, a QR code, an alphanumeric code, a bar code, another NFT, or a combination thereof.

3. The system of claim 1, wherein the one or more UIACs provides access to a physical event, a digital event, or a combination thereof.

4. The system of claim 1, wherein the one or more UIACs is associated with the NFT for access at the time of NFT minting.

5. The system of claim 1, wherein the one or more UIACs is associated with the NFT for access after the minting of the NFT.

6. The system of claim 1, wherein the one or more UIACs is associated with the NFT for access when a user requests the one or more UIACs.

7. The system of claim 1, wherein the operations further comprise providing the one or more new UIACs to the transferee or buyer.

8. A computer-implemented method of operating a NFT for Access comprising:
a) providing a non-fungible token (NFT) for access, wherein the NFT for access is associated with one or more unique identifier access codes (UIACs);
b) presenting an interface allowing a user to prove ownership of the NFT for access and view the status of the UIACs;
c) monitoring for transfers or sales of the NFT for access on the blockchain;
d) if a transfer or sale of the NFT for access is detected:
i) de-authenticating all UIACs previously associated with the NFT for access; and
ii) creating one or more new UIACs associated with the NFT for access.

9. The method of claim 8, wherein the one or more UIACs comprises: a ticket, a QR code, an alphanumeric code, a bar code, another NFT, or a combination thereof.

10. The method of claim 8, wherein the one or more UIACs provides access to a physical event, a digital event, or a combination thereof.

11. The method of claim 8, wherein the one or more UIACs is associated with the NFT for access at the time of NFT minting.

12. The method of claim 8, wherein the one or more UIACs is associated with the NFT for access after the minting of the NFT.

13. The method of claim 8, wherein the one or more UIACs is associated with the NFT for access when a user requests the one or more UIACs.

14. The method of claim 8, wherein the method further comprises providing the one or more new UIACs to the transferee or buyer.
